(19) United States
(12) Patent Application Publication
(10) Pub. No.: US 2026/0249306 A1
(43) Pub. Date: Aug. 27, 2026

(54) INFLATABLE FROTH CROWDER APPARATUS FOR FLOTATION MACHINES

(71) Applicant: FLSmidth A/S, Valby (DK)

(72) Inventors: Dariusz Lelinski, Salt Lake City, UT (US); Thien Sok, Sandy, UT (US); Michael Stark, Cottownwood Heights, UT (US); Jake Albers, Salt Lake City, UT (US); Christopher Upham, Millcreek, UT (US)

(21) Appl. No.: 18/853,307

(22) PCT Filed: Apr. 1, 2023
(86) PCT No.: PCT/IB2023/053301

§ 371 Date: Oct. 1, 2024

Related U.S. Application Data
(60) Provisional application No. 63/326,393, filed on Apr. 1, 2022.

(51) Int. Cl. B03D 1/14

(52) U.S. Cl. CPC B03D 1/1493

(57) ABSTRACT

An inflatable froth crowder assembly (1) is disclosed. The inflatable froth crowder assembly (1) is configured for directing froth from a flotation machine tank (21) to a launder (25) of a flotation machine and comprises an inflatable body (2), at least one valve (25), and first tethering means (4) for securing the inflatable body (2) within the flotation machine (35) using second (15) and third tethering means (23). Also disclosed is a flotation machine (35) comprising the inflatable froth crowder assembly (1) and a method of installing the inflatable froth crowder assembly (1).

### CROSS-REFERENCE TO RELATED APPLICATIONS

None.

### FIELD OF THE INVENTION

Embodiments of the invention relate to novel froth crowder assemblies for flotation cells, in particular, inflatable froth crowder apparatus configured for use with naturally-aspirated (i.e., “self-aspirated” or “induced-air”), and/or “forced-air” flotation cells. Embodiments may be especially beneficial for facilitating installation, reducing manufacturing costs & energy/materials required to fabricate, increasing safety to operation and maintenance personnel, and/or facilitating adjustments for improved mineral recovery when employed and used in flotation processes. The novel inflatable froth crowder assemblies may include annular collar structures, without limitation. Some of these structures may be configured to be modular, or multi-part assemblies without limitation.

### BACKGROUND OF THE INVENTION

Flotation cells receive slurry containing ore particles. Some of the ore particles having a target mineral therein, and others contain unwanted gangue. Reagents (e.g., collectors/float-promotors, frothers, depressors/depressants, activators, pH regulators, sulphidizers) are generally used to improve and/or optimize flotation of such ore particles, for example, to float or inhibit flotation of the ore particles containing the target mineral therein. Conventional and “reverse” flotation practices are common. Reverse flotation involves suppressing particles of target composition and floating unwanted gangue.

To this end, there are several different types of flotation machines. Flotation column cells and those flotation machines which employ spargers or inverted fluidized beds (e.g., WO2011150455A1); those that use forced air introduced under pressure through a shaft and through a rotor surface (e.g., FLSmidth® Dorr-Oliver® flotation cells), and those which naturally-aspirate (e.g., FLSmidth® Wemco® flotation cells). Embodiments of the invention may conveniently exhibit industrial applicability with one, some, or all of these types of flotation cells using different configurations.

Flotation cells typically comprise a froth crowder assembly to direct flows of rising froth towards one or more upper froth collection launders provided to the flotation machine. Target particles in an infeed slurry are treated with a reagent, making them hydrophobic. The slurry is aerated with liquid in within the flotation machine by virtue of delivering air through spargers, or mechanically, via a spinning rotor. For the latter mechanical mechanism of aeration, the spinning rotor is typically disposed within close proximity to a surrounding disperser or stator structure to induce shear to the slurry-liquid (i.e., “pulp”) mixture and create air bubbles in the flotation machine tank.

The hydrophobic target particles attach themselves to the bubbles, and the bubbles lift the attached target particles towards the upper end of the flotation machine. Eventually, the bubbles (and the target particles attached thereto) make their way into one or more upper froth collection launders. In this regard, the target particles can be separated from gangue (which leaves the flotation machine through a lower outlet of the flotation machine).

In some instances, launders may circumferentially surround an outer peripheral portion of the flotation machine tank. An inner “doughnut” launder may be disposed radially-inwardly of an outer peripheral wall of the flotation machine tank. Radially-extending launders may be employed to increase launder surface area across the flotation machine tank in order to expedite and facilitate egress of froth collected at the top of the flotation machine. Various types of launder designs and configurations have been practiced to date.

Froth crowders are typically employed to flotation machines in various configurations to help direct or bias flows of froth (containing bubbles and target particles attached thereto) towards one or more froth collection launders. These froth crowders may take on many shapes and configurations. Typically, froth crowders are constructed of steel plate, making them bulky, heavy, and expensive to machine and fabricate. Because of their solid and bulky nature, installation/removal of traditional froth crowders around existing flotation machine structures can be difficult, and fine-tuned adjustments of the positioning of the froth crowders can be challenging. Moreover, access to lower portions of the flotation machine and internals may be hindered by froth crowder structures.

Although conventional froth crowder designs found within the prior art have demonstrated success within the flotation processing industry, it is desired to provide an improved froth crowder device which is configured to be easier and/or cheaper to manufacture, transport, service, adjust, and/or install.

### OBJECTS OF THE INVENTION

According to some embodiments, it is desired to provide a froth crowder apparatus which is configured to perform flotation processes more efficiently, and adjust to changing conditions such as pulp levels, pulp-froth interface levels, froth depth, froth layer thickness, and the like, without limitation.

According to some embodiments, it desired to provide an improved froth crowder apparatus which performs better than its conventional counterparts, without limitation.

According to some embodiments, it is desired to provide an improved froth crowder apparatus which allows for easier and/or cheaper manufacturing, transport, service, adjustment, and/or installation, without limitation.

It is further desired that embodiments provide a quick and easy way to enable access into a flotation cell (e.g., through simple deflation/inflation procedures).

These and other objects of the present invention will be apparent from the drawings and description herein. Although every object of the invention is believed to be attained by at least one embodiment of the invention, there is not necessarily any one single embodiment of the invention that achieves all of the objects of the invention.

### BRIEF SUMMARY OF THE INVENTION

An inflatable froth crowder assembly (1) is disclosed. The inflatable froth crowder assembly (1) is preferably configured for directing froth from a flotation machine tank (21) to a launder (25) of a flotation machine (35). The inflatable froth crowder assembly (1) may comprise an inflatable body (2). The inflatable body (2) may have an under surface (6) configured for directing flows of froth from within the flotation machine tank (21) towards the launder (25). The inflatable body (2) may comprise at least one chamber (18) therein for receiving a gas. The inflatable body (2) may be formed from a flexible resilient membrane (e.g., heavy PVC sheet, rubber, neoprene, urethane, Hypalon, or the like), without limitation. The at least one chamber (18) may be integrally-formed with an outer skin or layer of the inflatable body (2); or, it may comprise one or more separate inflatable bladders positioned and secured within an outer skin or layer.

The inflatable froth crowder assembly (1) may further comprise at least one valve (25) provided to a portion of the inflatable body (2). The at least one valve (5) may be configured for allowing ingress and egress of a gas.

The inflatable froth crowder assembly (1) may further comprise first tethering means (4) for securing the inflatable body (2) to a component of the flotation machine (35) or to a second component (3) of the inflatable froth crowder assembly (1). The inflatable froth crowder assembly (1) may be secured using a third tethering means (23), such as those depicted in FIGS. 6a-6j, without limitation.

In some embodiments, the inflatable froth crowder assembly (1) may comprise two components. A first component may comprise the inflatable body (2), and a second component (3) of the inflatable froth crowder assembly (1) may comprise a modular collar segment. The first component of the inflatable froth crowder assembly (1) may comprise a substantially different material than the second component (3). For example, the second component (3) may be fabricated of metal, such as steel.

In some embodiments, the second component (3) of the inflatable froth crowder assembly (1) may comprise second tethering means (15). The second tethering means (15) may be configured for operable engagement with the third tethering means (23). The third tethering means (23) may be provided between and operably engaging the first (4) and second (15) tethering means, without limitation.

The second component may be configured to be moved up and down and secured to another component of the flotation machine (35), such as to a standpipe (22), without limitation. The positioning and/or orientation of the inflatable body (2) within the flotation machine (35) may be adjusted by virtue of changing a length and/or tension of third tethering means (23) provided between and coupling the first tethering means (4) of the inflatable body (2) and second tethering means (15) provided to the second component (3).

In some embodiments, the second component (3)/modular collar segment may comprise an elongated arcuate body (16). The elongated arcuate body (16) may comprise a flange or abutment surface (13) on each of its distal ends. The elongated arcuate body (16) may be convex and/or configured to be mounted around or to a standpipe (22) provided to a central portion of a flotation machine.

The elongated arcuate body (16) may be concave and/or configured to be mounted to an inner surface of wall of a tank (21) of the flotation machine (35). In some embodiments, the second tethering means (15) may be provided directly to one or more portions of the tank (21). The second tethering means (15) may be provided to a convex side/surface of the arcuate body (16). A plurality of the second component (3)/modular collar segment may be connected together at respective flange or abutment surfaces (13). For example, as suggested in the figures, second components (3)/modular collar segments may be bolted together at their respective distal ends to form a ring that secures to a standpipe (22) using friction and hoop stresses which clamp the second components (3)/modular collar segments to the standpipe (22).

In some embodiments, one or more internal webs (17) may extend within the inflatable body (2). For example, each of the one or more internal webs (17) may connect at least two of the following portions of the inflatable body (2) together: an upper surface (10), an under surface (6), an inner profile (8), an outer profile (9).

In some embodiments, the inflatable body (2) may comprise a plurality of inner chambers (18) therein. Each of the inner chambers (18) may be separated from fluid communication with one another by at least one of said one or more internal webs (17), without limitation. In this regard, one or more internal webs (17) may define portions of an inner air bladder. It should be understood that one or more internal webs (17) may be employed to retain structure, strength, or shape of the inflatable body, or provide separation means for separate air bladders provided within an outer skin layer of the inflatable body (2).

In some embodiments, the inflatable body (2) may comprise means (19) for receiving and/or securing ballast (20). The ballast (20) may be provided in solid or liquid form. The means (19) for receiving ballast may comprise posts on an upper surface (10) for receiving doughnut-shaped weights, pockets provided to an outer skin layer of the inflatable body (2), straps or buckles provided to an outer skin layer of the inflatable body (2), or an inner bladder (32) for receiving/expelling a fluid. The inflatable body (2), thus, may be configured for adjusting its weight, buoyancy, and/or displacement of froth within the flotation machine (35).

In some embodiments, the inflatable body (2) may comprise one or more inflation tubes (7). The one or more inflation tubes (7) may extend from the inflatable body and/or may fluidly communicate with a holding tank (29) containing pressurized gas, without limitation. As suggested in FIG. 10, if a plurality of inflation tubes (7) are employed, they may each fluidly communicate with an air distribution manifold (31).

In some embodiments, the inflatable froth crowder assembly (1) may comprise at least one of the following: means (5, 26) for preventing over-pressurization of the inflatable body (2), means for maintaining and/or regulating the pressure of gas within the inflatable body (2), means for controlling the pressure of gas within the inflatable body (2).

The inflatable body (2) may be configured to be situated in the tank (21) and secured within the tank (21) with a clearance between the launder (25) and an inner (8) or outer (9) profile of the inflatable body (2). In some embodiments, such as the one shown in FIGS. 5a and 5b, it may be desirable to limit or remove a clearance between an inner profile (8) and a second component (3) of the assembly (1), or a component of the flotation machine (35) such as a standpipe (22).

In some embodiments, the third tethering means may be selected from the group consisting of: a cable, a rope, a chain, a carabiner, and a turnbuckle.

A flotation machine (35) may comprise the inflatable froth crowder assembly (1) according to any one of the preceding embodiments.

A method of installing a froth crowder assembly into a flotation machine (35) is further disclosed. The method may comprise the step of providing the inflatable froth crowder assembly (1) and flotation machine (35) according to any one of the preceding embodiments. The method may comprise the step of introducing a gas to the at least one chamber (18) within the inflatable body (2). The method may comprise the step of inflating the inflatable body (2) up to a predetermined pressure (e.g., to take up space within the flotation machine tank (21). The method may comprise the step of securing the inflatable body (2) to the flotation machine (35) by virtue of attaching the first tethering means (4) to the third tethering means (23). The third tethering means (23) may, in turn, be attached to second tethering means (15) provided to a second component (3) of the assembly (1), or to a component (21, 22, 25, 34) of the flotation machine (35).

### DESCRIPTION OF THE DRAWINGS

To complement the description which is being made, and for the purpose of aiding to better understand the features of the invention, a set of drawings illustrating preferred, non-limiting embodiments of an improved inflatable crowder assembly and components thereof for use in flotation machines is attached to the present specification as an integral part thereof, in which the following has been depicted with an illustrative and non-limiting character. It should be understood that like reference numbers used in the drawings.

FIG. 1 depicts a non-limiting exemplary embodiment of an inflatable froth crowder component comprising an inflatable body 2 constructed from a membrane and having at least one valve and means for connecting the inflatable body to a second component 3 of the inflatable froth crowder apparatus 1 or to another component 21, 22, 25, 34 of a flotation machine. The inflatable body 2 may be constructed with various integral underbody shapes for different flotation machine designs. The upper surface 10 and under surface 6 may be shaped and/or configured such that the inflatable body 2 may be flipped (i.e., reversible in its orientation within a flotation machine 35), without limitation. Symmetrical design of the inflatable body 2 may reduce fabrication costs and/or the number of part numbers.

FIG. 2 shows a detailed close-up view of a portion of FIG. 1, and suggests one non-limiting exemplary embodiment of means for connecting the inflatable body 2 to a second component 3 of the inflatable froth crowder apparatus 1 or to another component of a flotation machine 35. The inflatable body 2 may be provided with at least one valve fluidly communicating with at least one respective inner chamber or bladder 18 for receiving and maintaining a pressurized gas (e.g., air) within.

FIG. 3 suggests a non-limiting exemplary embodiment of a second component 3 of the inflatable froth crowder apparatus 1, in particular, a modular collar section which may be connected to a standpipe 22 of a self-aspirated flotation machine 35 (e.g., of an FLSmidth® brand WEMCO® 1+1 flotation cell).

FIG. 4 suggests that in some non-limiting embodiments, means 19 for adding ballast 20 to one or more portions of the inflatable body 2 may be employed to an inflatable body 2 of an inflatable froth crowder assembly 1. Shown, are optional weights which may be inserted into pockets integrally provided to the inflatable body. However, while not shown, weights could be clipped, adhered, received by, or alternatively fastened to independent portions of the inflatable body, without limitation. Weights 20 may be provided internally within the inflatable body 2 (e.g., sewn or glued into internal pockets within the inflatable body 2).

Weights 20 may be provided as sand, gravel, or steel/lead shot provided to one or more inner chambers 18, without limitation.

FIGS. 5a & 5b show isometric views of the inflatable body of FIG. 1 and modular collar section of FIG. 3 collectively installed in a flotation machine 35 (e.g., an FLSmidth® WEMCO® 1+1 flotation cell). Tethering means 23 may be provided between the two components 2, 3 to secure them to each other. Tethering means 23 may be selected or adjusted to effect proper relative positioning of the inflatable body 2 within the flotation machine 35.

FIGS. 6a-6j suggests various non-limiting embodiments of tethering means which can be used to secure an inflatable body 2 defined herein to another component of the inflatable froth crowder apparatus 1 or to another component of a flotation machine 35. First 4 and second 15 tethering means may be similar, different, or share features, without limitation. Second tethering means 15 may be applied to other components of a flotation machine 35, such as to a standpipe 22, launder 25, or steel beam 34, without limitation.

FIG. 7 is an alternative non-limiting embodiment of an inflatable body 2 of an inflatable froth crowder apparatus 1 which is configured for use between radial launders 25 of a flotation machine 35.

FIG. 8 depicts the arrangement of a plurality of the inflatable body 2 of FIG. 7 within a flotation machine 35 having radial launders 25 (e.g., an FLSmidth® Dorr-Oliver® flotation machine).

FIG. 9 shows a close-up view of a portion of FIG. 9, more clearly showing how inflatable bodies 2 may be tethered according to some non-limiting embodiments.

FIG. 10 depicts a schematic representation of a system for inflating chambers 18 of one or more inflatable bodies 2 using process gas or air. As suggested in FIG. 10, inflatable bodies 2 discussed herein may be optionally equipped with a chamber 32 configured to be used as a ballast bladder. As depicted, means for receiving and/or removing liquid ballast from the ballast chamber 32 of one or more inflatable bodies 2 may be provided to the system. In this regard, embodiments anticipate the independent control of buoyancy, displacement, and/or inflatable body location/orientation within the tank 21 during flotation machine 35 operation.

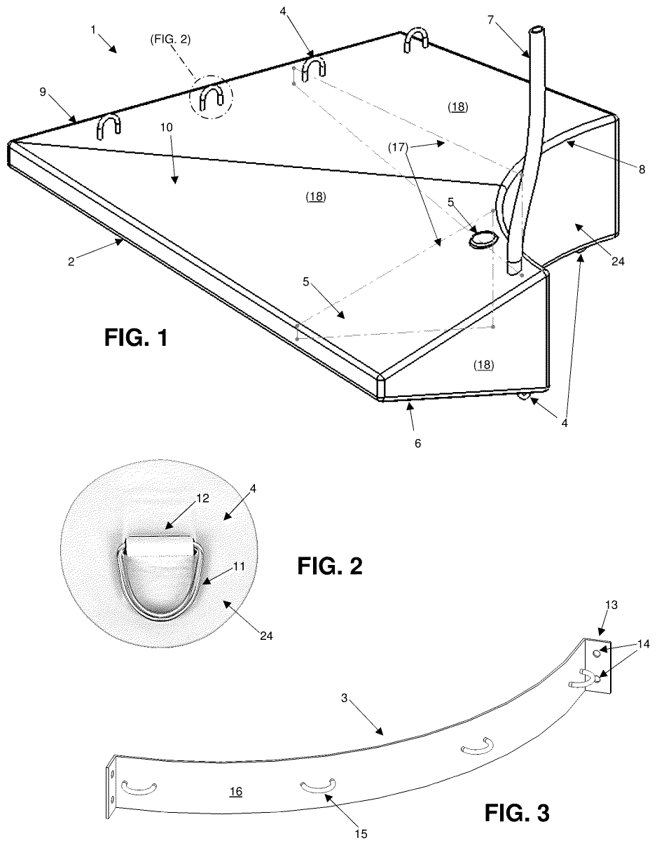

In the following, the invention will be described in more detail with reference to drawings in conjunction with exemplary embodiments.

### DETAILED DESCRIPTION

A novel inflatable froth crowder apparatus 1 for a flotation machine 35 is disclosed. The inflatable froth crowder apparatus 1 is configured for being placed within a flotation machine tank 21.

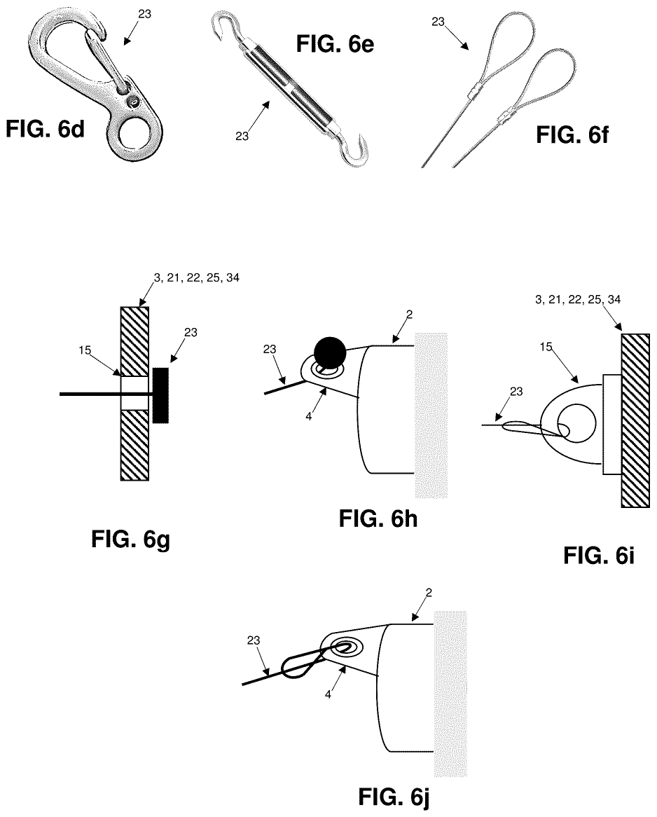

The inflatable froth crowder apparatus 1 may comprise an assembly, for example, a first component of the assembly comprising an inflatable body 2, and a second component of the assembly comprising a modular collar section 3. The inflatable body 2 component may comprise first tethering means 4, such as a D-ring, grommet, integral tether, connector, or the like. The modular collar section 3 may comprise complimentary second tethering means 15 for communicating with the first tethering means 4. The second tethering means 15 may comprise similar devices as the first tethering means, without limitation. However, as depicted in FIGS. 3, 6g, and 6i, eyebolts, affixed/welded ring segments, through holes, and other mechanical means may be provided. Third tethering means 23 may be provided between the first 4 and second 15 tethering means. The third tethering means 23 may comprise a cable, rope, chain, carabiner, turnbuckle, or the like, without limitation. It should be understood that the second tethering means 15 may be provided to other structures of a flotation machine 35, such as steel beams 34, one or more launders 25, stand-pipes 22, or other components. It should also be understood that third tethering means 23 may be selected (e.g., length) or adjusted to maximize stability of the inflatable body 2 and/or to optimize positioning of the inflatable body 2 within the tank 21.

Embodiments of the inflatable body 2 may comprise one or more internal bladders or chambers 18 formed from a flexible membrane material (e.g., glued or welded PVC sheets). The one or more internal bladders or chambers 18 may be defined by one or more webs 17 and an outer skin layer of the inflatable body. In some embodiments, the one or more internal bladders or chambers may be separate chambers provided within the outer skin layer of the inflatable body 2. The one or more webs 17 may be formed from flexible or rigid members which may serve to fluidly isolate each internal bladder/chamber 18, and/or help provide structural integrity of the inflatable body 2. It is preferred that the inflatable body 2 maintains structural integrity and a three-dimensional shape when inflated.

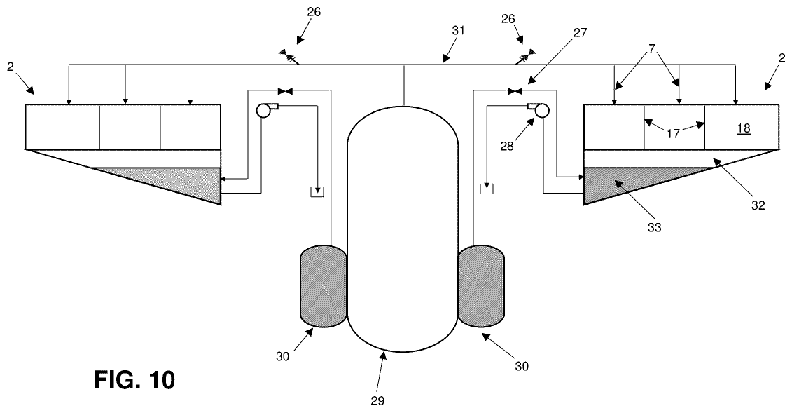

To facilitate inflating and deflating of the body 2, one or more valves 5 may be provided to the inflatable body 2. The valve(s) 5 may be configured and positioned in such a way that access is easy after installation into a flotation machine tank 21. Preferably, the valve(s) 5 are provided to a location which is not subjected to abrasion, wear, froth, or slurry, such as at a high point of upper surface 10. A valve 5 provided to the inflatable body 2 may comprise a “deflate only” valve, an “inflate only” valve, or an “inflate & deflate” (i.e., 2-way) valve, or “blow-off” valve, without limitation. As shown, valves may be operatively coupled to and/or fluidly communicate with one or more inflation tubes 7. For example, an over-pressurization valve 5, 26 may be provided in-line or stemming off of one or more inflation tubes 7 or manifolds 31 connected thereto (e.g., as suggested in FIG. 10).

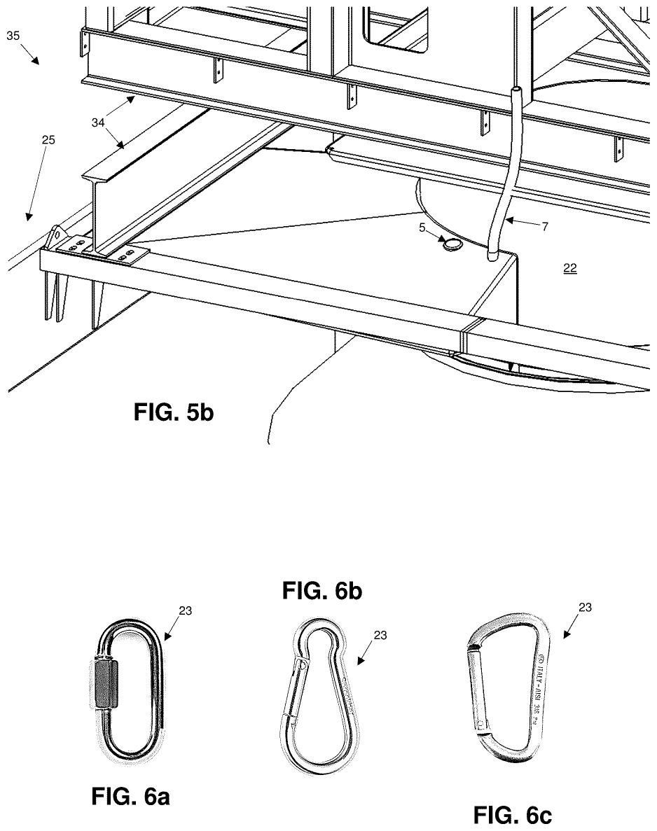

The inflatable body 2 may comprise an inner profile 8 which preferably complements inner structural geometries or inner surfaces of components 22 of the flotation machine 35. For example, an inner profile 8 may comprise an arcuate concave surface for providing clearance for a centrally-disposed standpipe 22, as depicted in FIGS. 5a & 5b. The inflatable body 2 may further comprise an outer profile 9 which preferably complements outer structural geometries or surfaces of components of the flotation machine 35 which are provided along outer portions of the floatation machine 35. For example, the outer profile 9 may be configured to be positioned adjacent an inner surface of a wall of a tank 21 of the flotation machine 35, and/or, in close proximity to a launder 25.

In addition to inner 8 and outer 9 profiles, the inflatable body 2 may comprise an upper surface 10 and an under surface 6. The upper 10 and/or under 6 surfaces may take on various shapes including shapes which are different than shown in the figures. It is preferred that the under surface 6 geometry be optimized for most efficiently directing froth from the flotation machine tank 21 to one or more launders 25 provided to the flotation machine. The under surface 6 may represent a similar shape and/or configuration to its prior art conventional steel counterpart, without limitation. The under surface 6 may comprise one or more layers of film for improved chemical-inertness and or sacrificial wear protection. The film may be fabricated as a removable/replaceable sheet laminate applied to the under surface 6; or, the film may be provided as a spray coating film or under surface treatment to protect the inflatable body from abrasion and/or chemical degradation. For areas of potential rubbing, extra layers of material may be provided to the inflatable body 2. For example, surfaces along the inner profile 8 may comprise wear layers (e.g., neoprene sheet) to prevent damage to the inflatable body 2 caused by rubbing against the standpipe 22. Other reinforced portions 24 (e.g., patch, strip, or additional layer of membrane material) may be provided at wear spots or areas where stresses may be applied to the inflatable body (e.g., adjacent first tethering means 4).

As suggested in FIG. 2, the first tethering means 4 provided to the inflatable body 2 may comprise a D-ring 11 which is permanently-secured to an outer surface portion of the inflatable membrane by an integral web 12. Such an arrangement may be similar to those commonly found on an inflatable raft or dingy. The integral web 12 may be plastic welded, chemically bonded/adhered, or stitched to the inflatable body 12 and sealed with a seam sealing glue or sealant, without limitation. One or more reinforcing portions 24 may be provided adjacent the first tethering means 4.

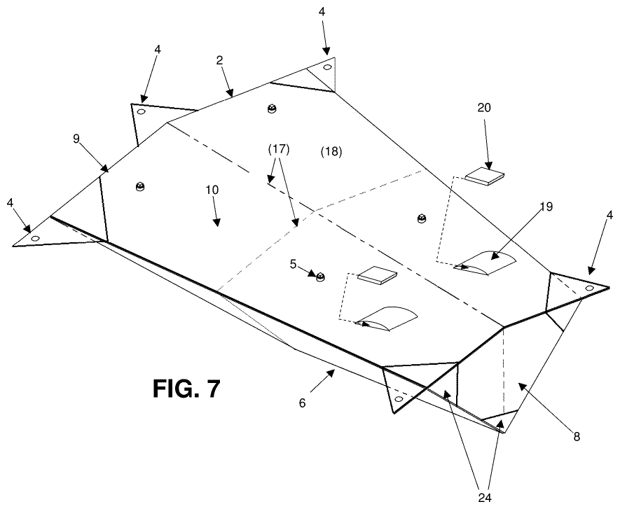

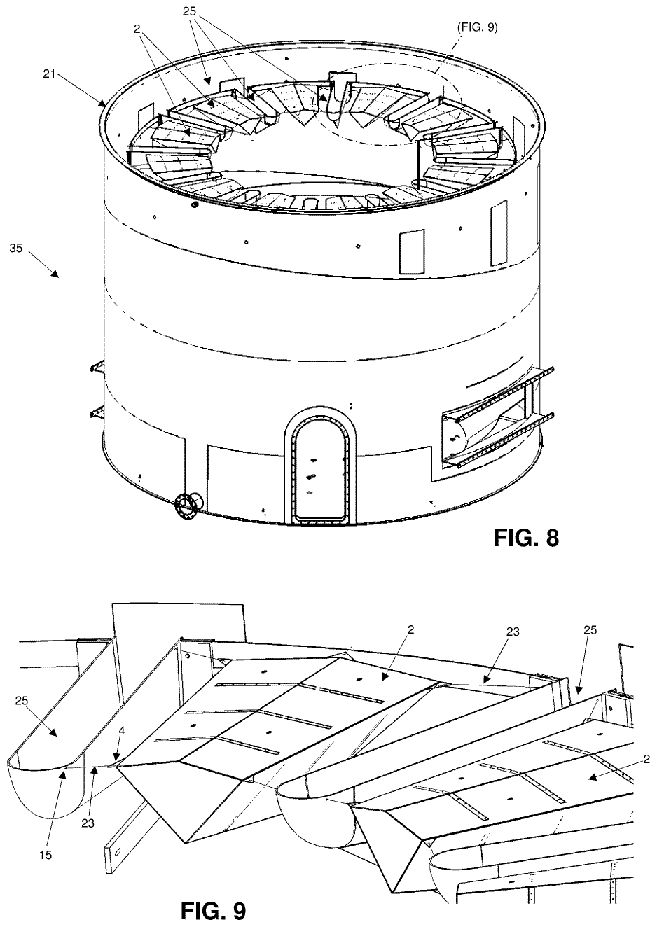

Optionally, one or more reinforced portions 24 may be provided to the inflatable body 2, particularly adjacent locations where first tethering means 4 or other securing features may be situated. For example, flexible reinforcing patches or strips may be provided to portions of the inflatable body 2 adjacent the inner 8 and/or outer 9 profiles. The one or more reinforced portions 24 may be preferred at internal and/or external corner portions of the inflatable body 2, or at areas where rubbing or stresses to the inflatable body might be anticipated. As can be inferred from FIG. 7, reinforced corners may be practiced to protect against abrasion and enable cinching/tensioning of third tethering means 23.

In some embodiments the inflatable body 2 may comprise a single internal chamber 18 configured for receiving a gas, such as air. The inflatable body 2 is preferably configured to hold the gas at a pressure above ambient, e.g., between 3 and 12 psi, and up to 25 psi, without limitation. In some embodiments, the inflatable body 2 may comprise a plurality of internal chambers 18 configured for receiving a gas, such as air. The plurality of chambers 18 may be at least partially defined by one or more internal webs 17 or baffle structures, without limitation. The webs 17 may be flexible, semi-flexible, or rigid, without limitation. In some instances, one or more webs 17 may extend between the upper 10 and under 6 surfaces or between inner 8 and outer 9 profiles (e.g., within one or more chambers 18), and may be configured to serve only as means of providing supplemental rigidity, strength, and shape-holding ability to the inflatable body 2 during/after inflation. In some embodiments, separate bladders may be provided within an outer skin layer of the inflatable body 2 to define the one or more internal chambers 18.

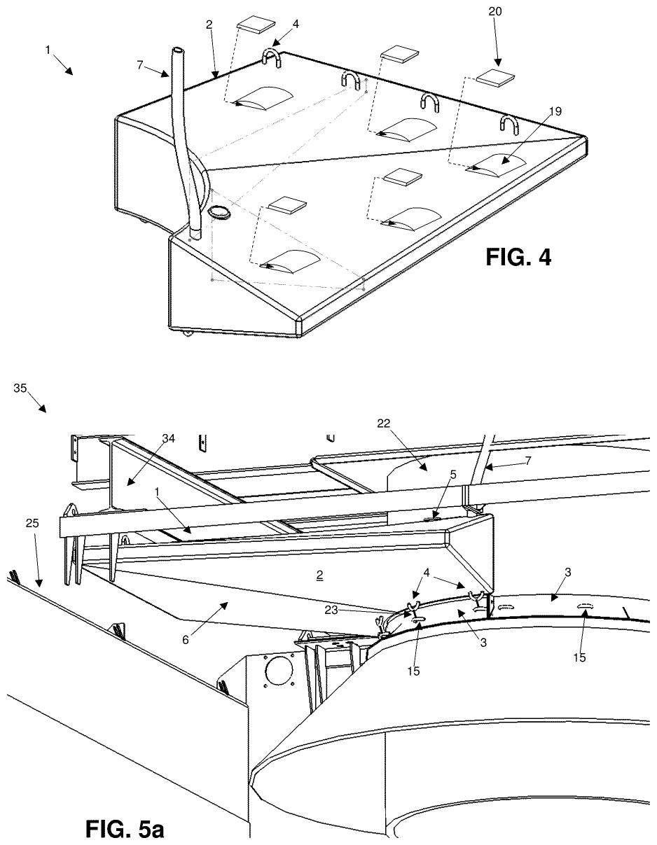

As may be inferred from FIG. 4, means 19 for receiving and/or securing ballast 20 to one or more portions of the inflatable body 2 may be provided, without limitation. Such means 19 may include, for example, one or more pockets 19 for receiving ballast 20 in the form of weights. The weights may comprise shot, lead diving weights, or the like. It is anticipated that other means 19 for receiving ballast may include straps, clips, or belts for securing ballast 20 to the inflatable body 2. Even more alternatively, a vertically-extending post extending upwardly from the upper surface 10 of the inflatable body for receiving one or more doughnut-shaped weights may be employed for receiving/securing ballast 20. The means 19 for receiving and/or securing ballast 20 may be provided to the upper surface 10 as shown, for maximum accessibility, or, the means 19 may be provided to other portions (e.g., to under surface 6, inner profile 8, outer profile 9, or to tethering means 4, 23), without limitation.

As can be appreciated from FIG. 10, ballast 20 may comprise a liquid ballast 33, such as process water, and said means 19 for receiving and/or securing ballast 20 may include a ballast bladder/chamber 32 provided to an internal or external portion of the inflatable body 2. In such embodiments incorporating the use of a liquid ballast, the ballast bladder/chamber 32 may be operably connected to and/or fluidly communicate with a liquid ballast holding tank 30. A hydraulic inlet valve 27 may be placed on an inlet line connecting the ballast bladder/chamber 32 to the liquid ballast holding tank 30 to allow fluid to enter the ballast bladder/chamber 32 in a controllable manner. A hydraulic purge pump 28 may be provided to an exhaust line fluidly communicating with the ballast bladder/chamber 32 to remove liquid ballast from the ballast bladder/chamber 32.

It is anticipated that a system similar to that shown in FIG. 10 may be employed for solid ballast (e.g., sand, gravel, or steel/lead shot).

Turning now to FIG. 3, a second component 3 of an assembly forming the inflatable froth crowder apparatus 1 may comprise a modular collar section 3 defined by an elongated arcuate body 16 having a flange or abutment surface 13 at each of its distal ends. Each flange or abutment surface 13 may be provided with connecting means 14, such as one or more holes for receiving fasteners such as bolts and nuts. The connecting means 14 may be configured to enable other modular collar sections 3 to be connected together around a standpipe 22. In some embodiments, connecting means 14 may simply comprise weld surfaces of the flange or abutment surface 13 for welding adjacent modular collar sections 3 together, without limitation. When connected together, the modular collar sections 3 may collectively form a clamp which secures them to an outer diameter surface of the standpipe 22. By loosening and tightening the connecting means 14, the modular collar sections 3 may be raised and/or lowered relative to the standpipe 22. Accordingly, using the same third tethering means 23, the inner profile 8 portion of the inflatable body 2 may be moved upward or downward in the tank 21 of the flotation machine 35 by virtue of placement of the second components 3 of the assemblies 1.

Turning now to FIG. 10, while one or more traditional valves 5 may be employed to fill and/or deflate inflatable bodies 2 (i.e., where the inflatable body 2 is filled and then capped after installation), it may be desirable to control inflation/deflation online, for example, using a distributed control system (DCS). In such cases, a holding tank 29 which is configured to hold pressurized gas such as nitrogen or air may communicate with an air distribution manifold 31. The air distribution manifold 31 may fluidly communicate with one or more inflation tubes 7. Each inflation tube 7 may fluidly communicate with one or more respective internal chambers 18. A blow-off valve 26, regulator, control valve, or other means for preventing over-pressurization of the one or more internal chambers 18 may be provided to the system. For example, a blow-off valve 26, regulator, control valve, or other means for preventing over-pressurization may be provided to the manifold 31, holding tank 29, inflation tubes 7, or valves 5, without limitation.

It should be known that the specific features, functions, process steps, and possible benefits shown and described herein in detail are purely exemplary in nature and should not limit the spirit and/or scope of the invention.

Moreover, although the invention has been described in terms of particular embodiments and applications, one of ordinary skill in the art, in light of these teachings, can generate additional embodiments and modifications without departing from the spirit of the claimed invention.

Accordingly, it is to be understood that the drawings and descriptions herein are proffered by way of example to facilitate comprehension of the invention and should not be construed to limit the scope thereof.

### LISTING OF REFERENCE NUMERALS

1 Inflatable froth crowder apparatus
2 Inflatable body (first component of an inflatable froth crowder assembly)
3 Modular collar section (second component of an inflatable froth crowder assembly)
4 First tethering means (e.g., D-ring, grommet, integral tether)
5 Valve (deflate only, inflate only, or inflate & deflate (2-way), blow-off valve)
6 Under surface (which can comprise various integral underbody shapes)
7 Inflation tube
8 Inner profile (of inflatable body)
9 Outer profile (of inflatable body)
10 Upper surface (of inflatable body)
11 D-ring
12 Integral web (for securing D-ring to inflatable body)
13 Flange or abutment surface
14 Connecting means (e.g., holes for receiving fasteners, bolts, or weld surfaces)
15 Second tethering means (e.g., eyebolts, affixed/welded ring segments, through hole)
16 Arcuate body
17 One or more internal webs (optional
18 One or more internal chambers (optional)
19 Means for receiving and securing ballast to inflatable body
20 Ballast (e.g., weights, steel/lead shot, fillable bladders)
21 Flotation machine tank
22 Standpipe
23 Third tethering means (e.g., cable, rope, chain, carabiner, turnbuckle, etc.)
24 Reinforced portion (e.g., patch, strip, or additional layer of membrane material)
25 Radial launder/froth collector
26 Blow-off valve
27 Hydraulic inlet valve
28 Hydraulic purge pump
29 Pressurizable gas (e.g., air) holding tank
30 Liquid ballast holding tank
31 Air distribution manifold
32 Ballast bladder/chamber
33 Liquid ballast
34 Liquid ballast
35 Flotation machine

1. An inflatable froth crowder assembly (1) configured for directing froth from a flotation machine tank (21) to a launder (25) of a flotation machine (35) comprising:
an inflatable body (2) having an under surface (6) configured for directing flows of froth from within the flotation machine tank (21) towards the launder (25); the inflatable body (2) comprising at least one chamber (18) therein for receiving a gas, the inflatable body (2) being formed from a flexible resilient membrane;
at least one valve (5) provided to a portion of the inflatable body (2) and being configured for allowing ingress and egress of a gas; and
first tethering means (4) for securing the inflatable body (2) to a component of the flotation machine or to a second component (3) of the inflatable froth crowder assembly (1), using a third tethering means (23).

2. The inflatable froth crowder assembly (1) according to claim 1, wherein the inflatable body (2) comprises a first component of the inflatable froth crowder assembly (1), the inflatable froth crowder assembly (1) further comprising said second component (3) of the inflatable froth crowder assembly (1).

3. The inflatable froth crowder assembly (1) according to claim 2, wherein the second component (3) of the inflatable froth crowder assembly (1) comprises second tethering means (15) configured for operable engagement with the third tethering means (23); the third tethering means (23) being provided between and operably engaging the first (4) and second (15) tethering means.

4. The inflatable froth crowder assembly (1) according to claim 2 or 3, wherein the second component of the inflatable froth crowder assembly (1) comprises a modular collar segment comprising an elongated arcuate body (16).

5. The inflatable froth crowder assembly (1) according to claim 4, wherein the elongated arcuate body (16) comprises a flange or abutment surface (13) on each of its distal ends.

6. The inflatable froth crowder assembly (1) according to claim 4 or 5, wherein the elongated arcuate body (16) is convex and configured to be mounted to a standpipe (22) provided to a central portion of the flotation machine.

7. The inflatable froth crowder assembly (1) according to claim 4 or 5, wherein the elongated arcuate body (16) is concave and configured to be mounted to an inner surface of a wall of a tank (21) of the flotation machine.

8. The inflatable froth crowder assembly (1) according to any one of the preceding claims, further comprising one or more internal webs (17) extending within the inflatable body (2); each of the one or more internal webs (17) connecting at least two of the following portions of the inflatable body (2): an upper surface (10), an under surface (6), an inner profile (8), an outer profile (9).

9. The inflatable froth crowder assembly (1) according to claim 8, wherein the inflatable body (2) comprises a plurality of inner chambers (18) therein, and wherein each of the inner chambers (18) are separated from fluid communication with one another by at least one of said one or more internal webs (17).

10. The inflatable froth crowder assembly (1) according to any one of the preceding claims, wherein the inflatable body (2) further comprises means (19) for receiving and/or securing ballast (20).

11. The inflatable froth crowder assembly (1) according to claim 10, wherein the ballast (20) is provided in solid or liquid form.

12. The inflatable froth crowder assembly (1) according to any one of the preceding claims, wherein the inflatable body (2) comprises one or more inflation tubes (7) extending therefrom and communicating with a holding tank (29) containing pressurized gas.

13. The inflatable froth crowder assembly (1) according to claim 12, further comprising at least one of the following: means for preventing over-pressurization of the inflatable body (2), means for maintaining and/or regulating the pressure of gas within the inflatable body (2), means for controlling the pressure of gas within the inflatable body (2).

14. The inflatable froth crowder assembly (1) according to any one of the preceding claims, wherein the inflatable body (2) is configured to be situated in the tank (21) and secured within the tank (21) with a clearance between the launder (25) and an inner (8) or outer (9) profile of the inflatable body (2).

15. The inflatable froth crowder assembly (1) according to any one of the preceding claims, wherein the third tethering means is selected from the group consisting of: a cable, a rope, a chain, a carabiner, and a turnbuckle.

16. A flotation machine (35) comprising the inflatable froth crowder assembly (1) according to any one of the preceding claims.

17. A method of installing a froth crowder assembly into a flotation machine (35) comprising the steps of:
providing the inflatable froth crowder assembly (1) and flotation machine according to any one of the preceding claims;
introducing a gas to the at least one chamber (18) within the inflatable body (2);
inflating the inflatable body (2) up to a predetermined pressure; and
securing the inflatable body (2) to the flotation machine by virtue of attaching the first tethering means (4) to the third tethering means (23).
